(19) United States
(12) Patent Application Publication
(10) Pub. No.: US 2006/0259355 A1
(43) Pub. Date: Nov. 16, 2006

(54) Methods and systems for recommending media

(76) Inventors: Karim M.T. Farouki, Seattle, WA (US); Oliver Roup, Seattle, WA (US); John-David Salazar, Salt Lake City, UT (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(21) Appl. No.: 11/126,926

(22) Filed: May 11, 2005

(51) Int. Cl. G06Q 30/00

(52) U.S. Cl. 705/14

(57) ABSTRACT

The present invention allows for a computing device to collect data on the user's behavior while the user is interacting with digital media, either through listening to music, watching a video, or manipulating a document. The present invention works with servers, client software, and computing devices to seamlessly provide the user with a new media experience.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

This invention relates to the field of computer software for transferring data between computing devices. It includes the storage and transfer of digital media, execution of computer programs for data collection, operations of a web browser, and interactions with the Internet.

### BACKGROUND OF THE INVENTION

The world of media, like music, film, television programming, short animated features, pictures, etc., is a complex one for consumers to navigate. The sources of complexity are multifold. Literally, millions of pieces of media exist in any of these content categories, and typically, a good deal of a consumer's time is required to actually explore and sample these pieces of media and then decide what media is liked and what media is not liked. The present invention is applicable across all of these categories of media. For example, in the music space today, consumers may explore and find music by listening to radio companies. However, radio companies often obtain their music through a handful or small number of record labels. Furthermore, many of the radio companies are consolidated into conglomerates consisting of more than one radio company. Therefore, consumers are actually exposed to a small segment of the entire set of media that is available. One of the problems and challenges for the media industry, including the music industry, is empowering consumers to find and discover new media, or enabling merchants to proactively present, provide, and show consumers additional media.

The techniques that are used today to deliver new media to consumers typically fall into one of two categories: The first category looks for patterns and purchase groups or clustering, sometimes called collaborative filtering depending on the application. The second category uses consumer ratings.

Collaborative filtering is a model that has been popularized by several companies including Amazon.com, Inc. of Seattle, Wash. When visiting a website of an online vendor to purchase a particular piece of media, say a compact disc (CD), there may be a small dialog that says “users who bought this CD also enjoyed or also purchased the following”, and there may be a list of other potentially interesting pieces of media. The idea here is to note everything that everyone in a particular universe buys, and then note for a given piece of media what other pieces of media were often bought by the same consumer who bought the first piece. From this data, information may be provided to the consumer about an interesting new piece of media. This approach is passive in that it involves no additional work on behalf of the consumer. It relies on the collected purchase history and purchase habits of consumers. Merchants have no incentive to change nor to add value to the consumer's experience since consumers are purchasing anyway.

The second approach involves consumer ratings, which have been made popular by numerous web retailers. As a consumer reviews various media and considers pieces of media to be purchased, information may be provided to allow the consumer to rate how relevant that media is to the consumer or how much does the consumer like the media. Such ratings may be on a scale, such as one to five stars. The use of a rating system requires the consumer to be willing to invest the extra time to input and review ratings. As such, there will be a much richer set of information about the consumer's habits, rather than the relatively limited information as to whether a consumer did or did not buy a particular item. A ratings system can allow a by web retailer to analyze information describing the extent to which the consumer liked an item. Furthermore, a ratings system can allow a consumer to rate items that the consumer did not purchase from a given online retailer. For example, if a consumer owns a hundred CDs at home and visits the website of a web retailer for the first time, the consumer can rate eighty of the hundred CDs that the consumer enjoys as “five stars”, and rate the twenty CDs that are deemed inferior as “tow stars”. As a result, without actually purchasing from the web retailer, collaborative filtering may be used to recommend content to the consumer.

While both approaches have been used with varying degrees of success, both alone and in combination, questions remain as to how to improve the recommendation of media to consumers. How can more data be provided to a recommendations engine, other than the information discussed above? How can more accurate data be obtained from the consumer? How can data of high value be delivered to the consumer? And, how can this be done without requiring the consumer to be proactively involved, such as by rating media? Hours spent rating media at a website are tedious to most consumers, and therefore few consumers are willing to rate a large volume of media. If the tedium could be removed, perhaps through an automated process, a consumer's experience could be enhanced using the resulting extra data without burdening the consumer with the tedium of providing extensive ratings.

A solution is needed to overcome the deficiencies of the approaches discussed above. Collecting more or different information on a consumer's behavior may provide information that could lead to a richer experience for the consumer.

### BRIEF SUMMARY OF THE INVENTION

In accordance with the present invention, a consumer's usage habits of their media player on their computer can be used to determine consumer preferences. Information collected can include media on the consumer's computer, usage patterns, play lists that have been created, and so on. This collected information can be sent on a regular basis to servers located in the Internet. The servers manipulate the information with algorithms and calculations to provide new recommendations to the consumer regarding media. Furthermore, by partnering with portable media player devices, such as MP3 players, video players, and other devices, manufacturers may develop devices that will gather such usage information and synchronize with the consumer's computer to upload gathered data to the computer. The devices could install client software to facilitate the synchronization and enable the computer to perform the tasks mentioned earlier. Data would be sent from the computer to the servers in the Internet which, in turn, sends new data to the computer, then to the portable media player device.

The present invention allows a computing device to collect data on the user's behavior while the user is interacting with digital media, either through listening to music, watching a video, or manipulating a document. The present invention works with servers, client software, and computing devices to seamlessly provide the user with a new media experience. This disclosure describes, among other things, a method and system for recommending media.

A method for recommending media is provided that includes seamlessly collecting information from a user on the user's behavior to media at a first computing device. The collected information is communicated to a second computing device to create a set of recommendations for additional media as a function of the collected information. The set of recommendations is received from the second computing device.

Another method for recommending media is provided that includes providing at a server client software to install onto a first client. The client software operates to collect information as a function of a user's behavior to media. The collected information is received at the server to create a set of recommendations for new media. The set of recommendations is provided to the first client or a second client.

A system for recommending media is provided that includes at least one of a first client and a second client in communication with a server. The first client operates with client software to collect user data correlating to a user's behavior to a first media, and to send the user data to the server. The server operates to receive the user data, to create a set of recommendations for a second media, and to provide the set of recommendations to the first client or the second client.

A third method for recommending media is provided that includes collecting information indicative of a user's behavior to media at a first computing device. The collected information is communicated to second computing device to create a set of services for additional media as a function of the collected information. The set of services is received at the first computing device or a third computing device.

A fourth method for recommending media is provided that includes providing at a server client software to install onto a first client. The client software operates to collect information as a function of a user's behavior to media. The collected information is received at the server to create a set of services for new media. The set of services is provided to the first client or a second client.

Another system for recommending media is provided that includes at least one of a first client and a second client in communication with a server. The first client operates with client software to collect user data correlating to a user's behavior to a first media, and to send the user data to the server. The server operates to receive the user data, to create a set of services for a second media, and to provide the set of services to the first client or the second client.

### BRIEF DESCRIPTION OF THE SEVERAL VIEWS OF THE DRAWINGS

The present invention is described in detail below with reference to the attached drawing figures, which are incorporated herein by reference, and wherein:

FIG. 1 is a block diagram of an exemplary operating environment suitable for practicing an embodiment of the present invention;

FIG. 2A is first diagram of an exemplary operating service suitable for practicing an embodiment of the present invention;

FIG. 2B is second diagram of an exemplary operating service suitable for practicing an embodiment of the present invention;

FIG. 2C is third diagram of an exemplary operating service suitable for practicing an embodiment of the present invention;

FIG. 3 is a diagram of an exemplary recommendation engine suitable for practicing an embodiment of the present invention;

FIG. 4 is a diagram of an exemplary internal connection of an exemplary operating service suitable for practicing an embodiment of the present invention;

FIG. 5 is a flowchart illustrating an exemplary process for operating a computing device in accordance with an embodiment of the present invention; and

FIG. 6 is a flowchart illustrating an exemplary process for operating client software and a server in accordance with an embodiment of the present invention

### DETAILED DESCRIPTION OF THE INVENTION

The present invention will be better understood from the detailed description provided below and from the accompanying drawings of various embodiments of the invention, which describe, for example, methods and systems for recommending media using data from a user. The detailed description and drawings, however, should not be read to limit the invention to the specific embodiments. Rather, these specifics are provided for explanatory purposes that help the invention to be better understood.

The present invention allows for a computing device to collect data on the user's behavior while the user is interacting with digital media, either through listening to music, watching a video, or manipulating a document. The present invention works with servers, client software, and computing devices to seamlessly provide the user with a new media experience.

Having briefly described an overview of the present invention, an exemplary operating environment for the present invention is described below.

Exemplary Operating Environment

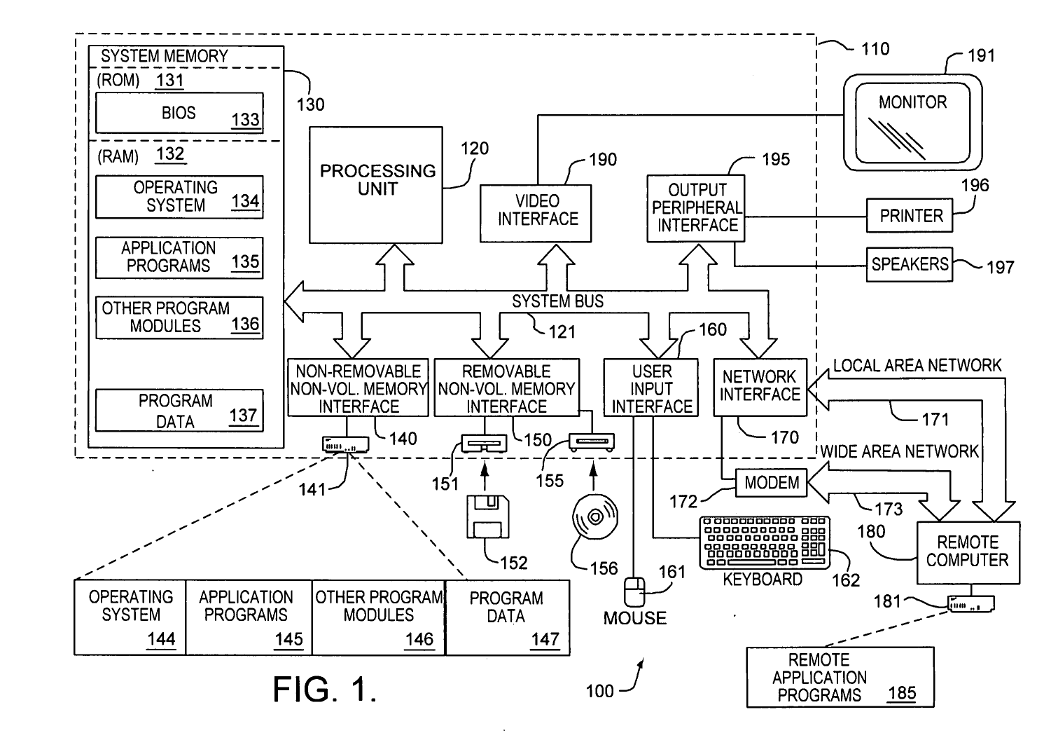

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between the various steps herein disclosed unless and except when the order of individual steps is explicitly described.

Media Recommendations

An embodiment of the present invention provides a user with a seamless way to obtain media or media recommendations based on monitoring and collecting data associated with the user's behavior. The user does not have to perform additional tasks associated with obtaining media or media recommendations. All the user has to do is to perform the user's tasks associated with interacting with the media. The present invention operates to do the rest of work by either providing the user with a set of recommendations for new media, providing the user with new media downloaded to a particular hardware device, or providing a set of services associated with the new media.

An embodiment of the present invention may function with various types of media. The media may include digital content that may be transferred across the Internet to devices that may receive it. The media may include audio, video, or documents, but is not necessarily limited to these types of media. The devices that may receive the media may be computing devices, such as servers, computers, workstations, handheld devices, computer-based clients, playback devices, or digital media players. A subset of computing devices is playing devices, such as the aforementioned handheld devices, playback devices, or digital media players. These lists are by no means exhaustive and may include a host of other devices capable of interacting with the Internet and other computing devices. Of the devices listed above, some of the devices may include MP3 players or similar devices capable of interpreting and responding to different media formats.

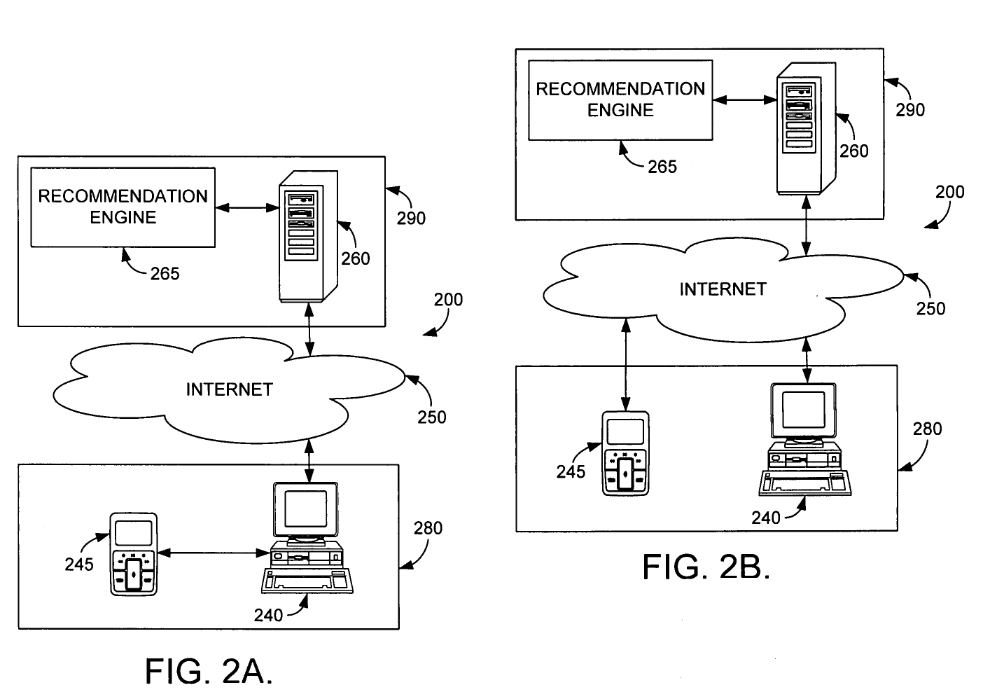

In FIG. 2A, a block diagram is shown illustrating a media network 200 with a computing device 240 connected to a handheld device 245 and Internet 250. Internet 250 is connected to a server 260 which is connected to a recommendation engine 265. As shown in FIG. 2A, computing device 240 and handheld device 245 are shown logically connected as a user 280 while server 260 and recommendation engine 265 are shown logically connected as a service 290. User 280 and service 290 may be referred to below as persons. Recommendation engine 265 is shown separate from server 260, but recommendation engine 265 may be a component of server 260 in practicing the present invention. Although the configuration shown in FIG. 2A is an embodiment of the present invention, other embodiments may be configured to implement the present invention different from the illustration shown. For example, server 260 may consist of a complement of servers or computers connected together. FIG. 2A, along with other figures, is merely exemplary.

User 280 interacts with service 290 through internet 250. Within service 290, recommendation engine 265 contains algorithms that analyze collected information from computing device 240 to provide recommendations for new media and/or to facilitate the new media being transferred to computing device 240. More details regarding recommendation engine 265 will be discussed below.

Computing device 240 may contain computer software that operates to perform a number of tasks associated with monitoring or collecting data regarding a user's behavior. Depending on the type of computer software, various information may be monitored or collected pertaining to the user. For example, a user's purchase patterns may be collected. A play list for media created by the user may be collected. Ratings information from the user regarding the user's behavior towards media may be collected. Statistics associated with the user's behavior may be collected such as a number of times the user plays a media item, the number of times the user includes a media item in a play list, or the number of times the user skips or avoids a media item. Time and date information may be collected, such as when a media item is played or determining when a media item was last played. All of this information may analyzed to provide insights into the user's behavior towards media items that the user likes. The information may be used to predict similar media items that may be provided to the user. From an operations perspective, computing device 240 collects one or more sets of the information discussed above and transmits it to server 260.

In some instances, user 280 may use a computer program operating on computing device 240 to manage and operate media items. For example, user 280 may listen to digital music on computing device 240 using a type of computer program known as a media player that operates on the computing device. A commercially-available media player is the WINDOWS MEDIA PLAYER from the Microsoft Corporation of Redmond, Wash. The media player may be used to collect information discussed above working in conjunction with whatever client software that may be installed on computing device 240. Once client software is installed, user 280 may go about his or her normal business to enjoy the media that has been or may be installed on computing device 240. An embodiment of the present invention operates in the background to collect the pertinent information without user 280's intervention.

In some instances, user 280 may not desire to use media on computing device 240. In other words, user 280 may not want to listen to digital music on computing device 240, but instead may want to listen to music on handheld device 245. Handheld device 245 may be an MP3 player or any number of handheld devices that are available from a variety of vendors. An example of handheld devices include flash memory portable playback devices and mini hard drive portable playback devices such as RIO players from Digital Network North America Company of Santa Clara, Calif. or NOMAD players from Creative Technology Ltd. of Singapore.

There are numerous handheld devices available with a wide range of functionalities. Most of them have in common the ability to load digital content from a computing device. Handheld devices may load digital content through an internet connection or from a direct connection to the computing device. In FIG. 2A, handheld device 245 connects to computing device 240 for the purpose of exchanging information. In an embodiment of the present invention, handheld device 245 may also collect behavioral information about user 280 with regards to media in a similar manner as information is collected on computing device 240. Furthermore, handheld device 245 and computing device 240 may synchronize information that is collected between them. This embodiment of the present invention allows both devices to share information as well as update each other when information changes on one device or the other. By synchronizing with computing device 240, handheld device 245 may ensure that information that is sent to server 260 may reflect user 280's behavior more accurately. For example, if user 280 listened to classical music on computing device 240 and listened to country music on handheld device 245, the synchronization between the two device may ensure that similar information on user 280's behavior is contained on both devices. Thus, when the information is sent to server 260 and recommendation engine 265, the algorithm may provide a digital content or recommendation for digital content that reflects user 280's affinity with both classical and country music. Likewise, when digital content is delivered to computing device 240, the synchronization process allows for the digital content to be shared with handheld device 245.

Turning now to FIG. 2B, a block diagram of media network 200 is shown with a similar configuration to FIG. 2A. In FIG. 2B, rather than a direct connection existing between computing device 240 and handheld device 245, both devices have connections to Internet 250. FIG. 2B illustrates yet another embodiment of the present invention. As discussed in FIG. 2A, client software may be installed on both computing device 240 and handheld device 245 in order to practice the present invention. Both devices may collect information as identified in FIG. 2A that pertains to user 280's behavior. Rather than handheld device 245 transferring information to computing device 240 and vice versa, handheld device 245 may transfer data directly to service 290 through Internet 250 similar to computing device 240. The reverse is also possible. Handheld device 245 may receive information from service 290 correlating to the collected information of either computing device 240, handheld device 245, or both. However, the more like scenario may be to use computing device 240 as a primary device for the collection of information. Computing device 240 may send collected information to service 290, but information or recommendations may be sent directly to computing device 240 or handheld device 245. This is different from FIG. 2A where handheld device 245 could only obtain information through a connection to computing device 240. In FIG. 2B, handheld device 245 may not need to connect to computing device 240. There is a possibility that handheld device 245 may synchronize with computing device 240 in some manner through an indirect connection through Internet 250.

Because client software may reside on both computing device 240 and handheld device 245, there may be a desire to have both devices synchronize with each other at some point. The idea here is to convey that both devices may play a role in influencing user 280's behavior and the resulting content and recommendations that is returned from service 290.

Another embodiment of the present invention may provide for partitioning of information so that each device may maintain its own data collection and results. For example, if user 280 listens to country music on computing device 240 and classical music on handheld device 245, the present invention may be configured to allow for the recommendations and subsequent content to flow accordingly. New country music may be recommended to computing device 240 and new classical music may be recommended to handheld device 245. However, one may keep in mind that both devices may have access to each other (albeit indirectly) to either review the contents in the other device or to synchronize information between both devices.

Although user 280 depicts two devices, many devices are capable of being configured to operate in the manner described above. For example, user 280 may implement an embodiment of the present invention with computing device 240, handheld device 245, a flash memory MP3 player, a DAISY player, or a digital video player. DAISY (Digital Accessible Information System) is a standard and format for digital talking books. The devices may operate with access to more than one service 290.

For clarity, client software may take the form of various computer software. Client software may consist of the media player and other computer software designed to carry out the functions discussed in the present invention. The term client software is used in a broad manner to denote various computer software that may be enabled to work with server 260 but resides in one form or another on computing device 240, handheld device 245, or other user devices.

Referring now to FIG. 2C, another block diagram of media network 200 is shown. This time, a computing device 270 is added in place of handheld device 245. An embodiment of the present invention may implemented in this configuration to show the interactions between computing device 240 and computing device 270. This configuration may occur in situations when a user 285 has a personal computer and a work computer. User 285 may use computing device 240 to perform the collection of information using client software which was described earlier. Although not shown, computing device 240 may also be used to synchronize with other devices as discussed earlier. The point here is to illustrate that computing device 240 may be the primary device for the collecting of information and receiving content and recommendations. However, a problem occurs when user 285 goes to work and finds that, at computing device 270, the same content that is loaded onto computing device 240 is not available. Several options may be available to user 285 at computing device 270. In a first option, computing device 270 may indirectly synchronize through Internet 250 to computing device 240. Software operating on computing device 240 and computing device 270 may allow an exchange of data. In a second option, computing device 270 may interact with service 290 in the same way as handheld device 245 in FIG. 2B by having client software installed. In this way, computing device 270 may receive content and recommendations based upon collected information sent to service 290 from computing device 240, computing device 270, or both. As was stated earlier, client software may allow for a synchronization between the two devices so that collected information may be shared between them.

Going back to the partitioning discussion, client software may be enabled so that computing device 240 and computing device 270 may appear to function independently and separately, although there is only one user 285 using service 290. Each device may be configured in practicing the present invention to contain its separate collected information as well as to receive its own recommendations, contents, and services.

One may appreciate that FIGS. 2A, 2B, and 2C show various embodiments of the present invention. More embodiments may be implemented as mentioned earlier. Devices may be added or subtracted from the configurations. The embodiments may be implemented to handle multiple users although most of the discussion focuses on one user.

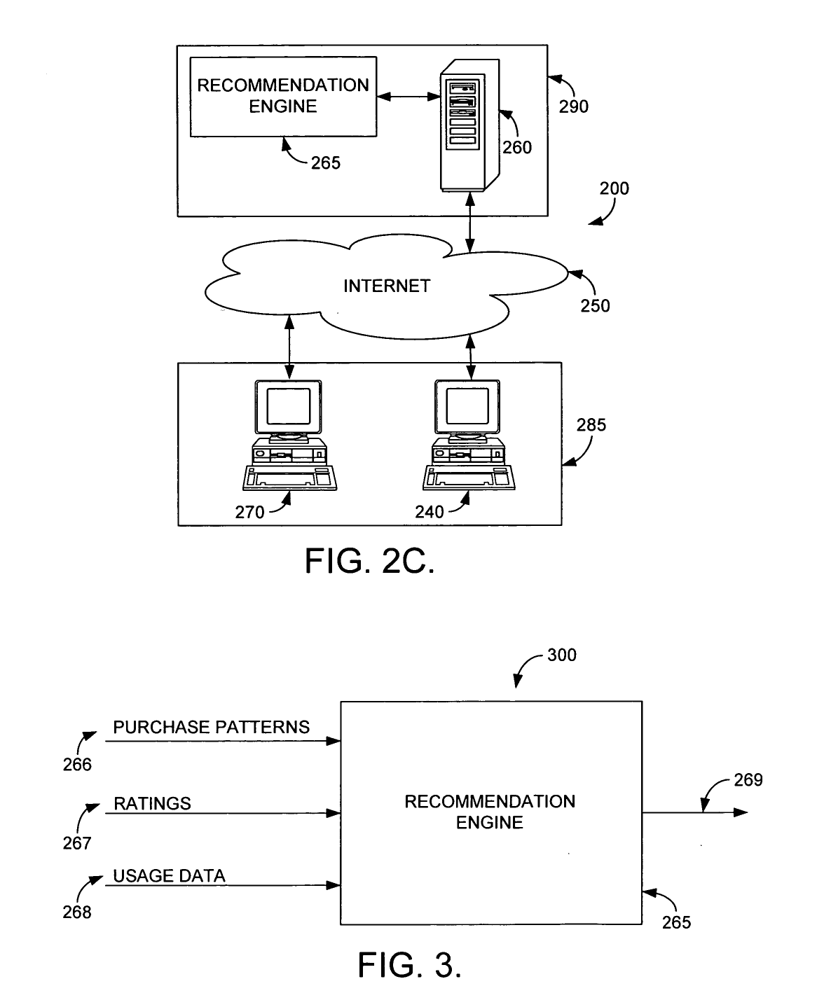

In FIG. 3, a block diagram of device 300 is shown with an expanded view of recommendation engine 265 from FIGS. 2A, 2B, and 2C. In this view, a purchase patterns 266, a ratings 267, a usage data 268, and an output 269 are shown. FIG. 3 is one embodiment depicting the various types of inputs that may feed into recommendation engine 265. However, different inputs may be fed into recommendation engine 265. FIG. 3 is meant to be exemplary of one embodiment. In FIG. 3, purchase patterns 266, ratings 267, and usage data 268 are inputs into recommendation engine 265. These three inputs correspond to the collected information that was discussed earlier in FIGS. 2A, 2B, and 2C. The inputs correspond to collected information at computing devices correlating to the user's behavior. Once the collected information is sent to server 260, the information is sent to recommendation engine 265 as inputs. It is assumed that each input may provide some insight into the user's behavior. Taken as a whole, the inputs may provide a comprehensive view into the user's desires and dislikes with regards to various types of media.

Data is collected for inputs into recommendation engine 265 in various ways. One way to collect data is to look for patterns in cluster groups of information sometimes identified by a process called collaborative filtering. Although collaborative filtering may exist as prior art, the present invention uses collaborative filtering in recommendation engine 265 in a seamless manner to find out how a user is working. Purchase patterns 266 may be collected using collaborative filtering. However, it may be collected by tracking the user's habits alone without making any comparisons to other users.

Another way to collect data is to explicitly rate the media into several categories. A ratings program may be installed on a computing device, or a web site may offer the user an opportunity to rate a piece of media. The ratings information may be tracked and collected to form as an input into recommendation engine 265. Likewise, ratings information identified by ratings 267 may be collected more implicitly. By collecting data on the user, implicit ratings information may be created regarding the user's behavior towards media. For example, if the user plays a particular song thirty times but always skips the same different song, one may assume that the user might like the song that was played thirty times assigning it a higher score than the song that is always skipped.

The present invention goes a step further. It implements a collaborative filtering approach, implicit ratings, and various usage data (usage data 268) in a seamless manner to input into recommendation engine 265. The various inputs for purchase patterns 266, ratings 267, and usage data 268 go through a set of calculations, filters, and algorithms to provide at output 269 either a recommendation of new media for the user, content related to new media, or information that leads to additional services for the user. As noted earlier, recommendation engine 265 is integrated with server 260. As such, server 260 and recommendation engine 265 may operate together to provide the user with either a recommendation for new digital media based on the user's behavior, a mechanism to automatically download new digital media, a service to provide concert information related to the user's desires, or a notification of new media releases.

The range of services that may be implemented with the present invention may extend further than those listed in the previous paragraph. For example, the present invention may scan the user's hard drive on computing device 240 or hand held device 245 to search for bad metadata in a media file. Although not conclusive, bad metadata may be associated with pirated media, especially in the case where media has been downloaded without a license. The same may be true for media that has been downloaded validly but the license is now expired. The present invention may facilitate a service to offer the user an opportunity to turn bad metadata into good metadata and provide a valid license in the process.

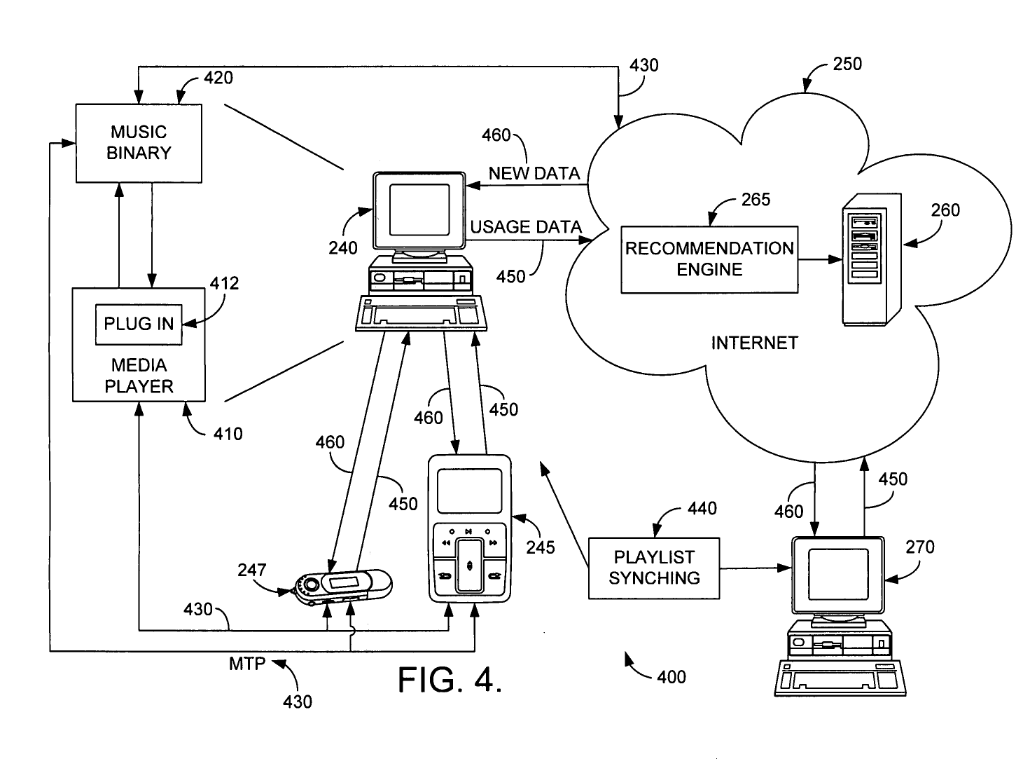

In FIG. 4 a block diagram is illustrated of an exemplary operating environment of the present invention. It is similar to the diagrams encountered in FIGS. 2A, 2B, and 2C. However, FIG. 4 includes exemplary connections illustrating how equipment may communicate to each other, and depicts possible computer software programs that operate on the computing device. In computing device 240, exemplary computer software programs are shown in a media player 410, a plug-in 412, and a music binary 420. Within computing device 240, these computer software programs communicate with each other and with other devices using a media transport protocol (MTP) 430. FIG. 4 also illustrates a transfer of data between devices as shown by a usage data 450 and a new data 460.

Media player 410 operates as a computer software program to play media files on computing device 240. Media player 410 may also perform some of the data collection in the present invention as well as act as a central interface between the user and other aspects of the present invention. An example of media player 410 is the WINDOWS MEDIA PLAYER by the Microsoft Corporation of Redmond, Wash. With media player 410, various functionality may be provided to the user. For example, the user may create, modify, and play a play list of music, videos, or other digital content. The play list is a list of media created by the user. The user may use the play list to play the media members within the play list. The play list may be modified at the discretion of the user, and may be stored on a number of devices including computing device 240, handheld device 245, and a flash handheld device 247. The user may also create, store, and play multiple play lists. Play lists may also form part of the collected information in the present invention because they imply a type of clustering or behavior.

Plug-in 412 is a computer software program that operates with media player 410. As the name implies, plug-in 412 may be changed, updated, or deleted as desired in practicing an embodiment of the present invention. In FIG. 4, plug-in 412 provides a conduit to transfer data between media player 410 and music binary 420.

Music binary 420 communicates with devices to enable the transfer of data between them as shown by usage data 450 and new data 460. In FIG. 4, music binary 420 communicates with handheld device 245 and flash handheld device 247 to collect data from those devices and store it on computing device 240. MTP 430 is the protocol that is used to facilitate the data transfer. However, usage data 450 and new data 460 contain the actual information that is transferred. As discussed earlier, handheld device 245 and flash handheld device 247 may collect various information as part of the present invention, discussed earlier in FIGS. 2A, 2B, and 2C. Some of the information may be collected by computing device 240 also shown earlier in the same figures. Client software operating on the devices notifies music binary 420 of usage data 450 to be collected and transferred. Music binary 420 sends usage data 450 to server 260 and recommendation engine 265 over Internet 250. Conversely, new data 460 is delivered from server 260 to music binary 420, which in turns sends new data 460 to the appropriate devices illustrated in FIG. 4. As discussed earlier in FIGS. 2A, 2B, and 2C, new data 460 may contain recommendations, new media, or other services for the user's benefit.

One may note that music binary 420 deals with digital music as illustrated in FIG. 4. However, other computer software programs may be implemented in practicing an embodiment of the present invention. For example, a video binary may used in place of music binary 420. A digital document binary may be used as well. Alternatively, some combination of audio, video, and digital document computer software may be implemented to practice the present invention. The point here is to note that the present invention deals with various media, and FIG. 4 is only one illustration of an embodiment using music media.

In FIG. 4, MTP 430 is illustrated with connections between Internet 250, music binary 420, media player 410, handheld device 245, and a flash handheld device 247. MTP 430 illustrates internal connections within computing device 240 and Internet 250. Other connections and configurations are possible and may be implemented in practicing an embodiment of the present invention. In addition, other protocols may be implemented rather than MTP 430. MTP 430 is merely an exemplary protocol to illustrate the possibilities in practicing an embodiment of the present invention.

As noted earlier in FIG. 2C, computing devices 240 and 270 may synchronize their data together as identified by a playlist 440. Playlist 440 may contain audio, video, or some other type of media. It may also contain a combination of all three as long as the content may be detected and played by media player 410, handheld device 245, or flash handheld device 247. Playlist 440 illustrates another aspect of the present invention whereby one device may share updated information with another device. As noted earlier, the user may use computing device 240 in a residence but have a desire to update computing device 270 at work. Playlist 440 and other data may be synchronized between the two devices using the present invention.

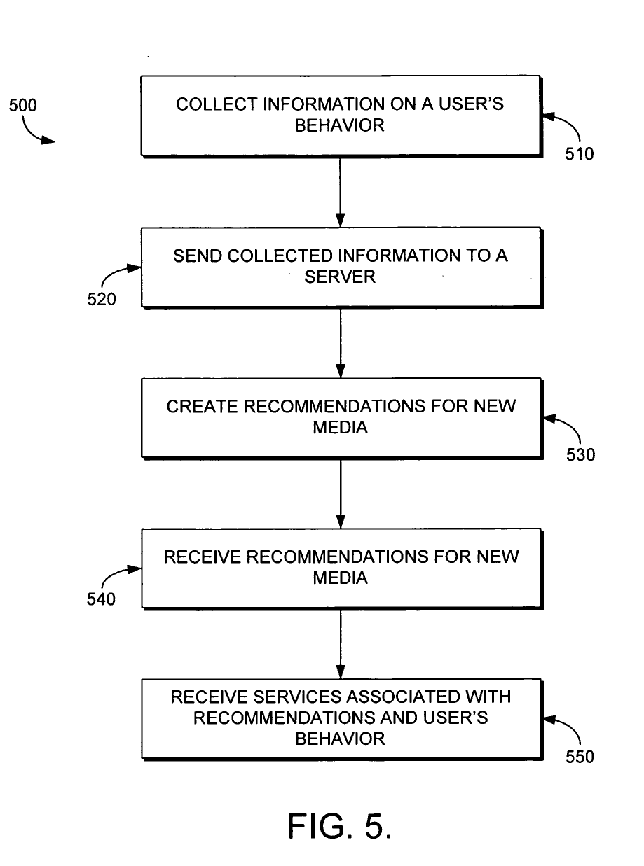

In FIG. 5, an exemplary process is shown illustrating an embodiment for practicing the present invention. At computing device 240, information may be collected on a user's behavior in a step 510. This step includes collecting information at handheld device 245 and transferring it to computing device 240. Several iterations may occur with information being collected and stored at either computing device 240 and handheld device 245. Likewise, several iterations may occur with computing device 240 delivering collected information to server 260 as shown in a step 520. Since collecting information and delivering information are not one-time occurrences, it is possible to have step 520 execute before step 510.

Collected information is delivered intermittently to server 260 in step 520 and becomes input into recommendation engine 265. In recommendation engine 265 and server 260, new recommendations are created based on the behavioral patterns received in the collected information, shown in a step 530. Although the illustrated process creates recommendations in step 530, other data may be created in practicing other embodiments of the present invention. As discussed earlier, digital content and other services may be created for delivery to computing device 240 or other devices. For purposes here, the discussion focuses on recommendations being created based on the collected information.

In a step 540, recommendations are received at the devices discussed in FIGS. 2A, 2B, and 2C. The recommendations correlate to the user's behavior based upon the collected information sent to server 260 and recommendation engine 265. These recommendations may change over time based due to several factors: A user's behavior may change over time influencing the way recommendations are created for that user; and the repertoire of information available to server 260 and recommendation engine 265 may change allowing for different types of recommendations to be made to the user, although the user's behavior may stay the same.

With recommendations of new digital content for the user, a host of services may be created and provided to the user as well. These services may be provided to the user as outlined in a step 550. FIGS. 2A, 2B, and 2C discussed earlier some of the services that might be possible with implementing the present invention.

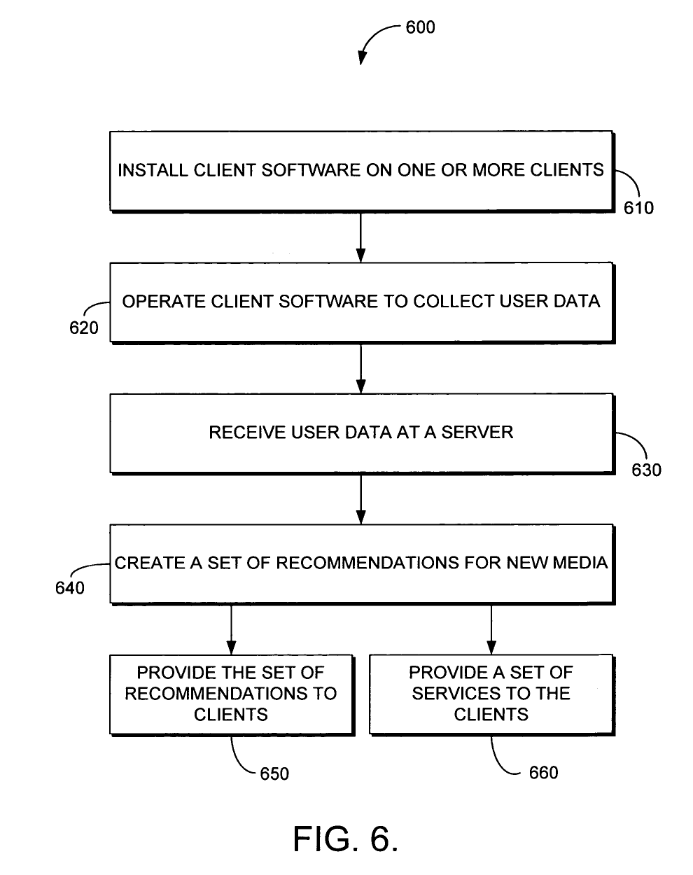

In FIG. 6, another exemplary process is shown illustrating an embodiment for practicing the present invention. In a step 610, client software may be installed in one or more computing devices. This may be computing device 240 as shown in FIGS. 2A, 2B, and 2C. Or, it may be handheld device 245 which may connect to computing device 240 or connect to a service provider indicated by server 260 and recommendation engine 265. Client software may be installed by the service provider onto the devices or it may be independently installed on the devices using a compact disc. Client software enables the devices to communicate with the service provider that is going to provide the recommendations, contents, or services through server 260 and recommendation engine 265.

In a step 620, the client software is operated to collect user data at the devices. This step is similar to step 510 in FIG. 5. At designated intervals, the collected information is transferred to server 260 as shown in a step 630. Server 260 may act as the primary interface to receive the collected information. But as discussed earlier, server 260 may be a complement of servers or computers operating together with recommendation engine 265. The activities of server 260 and recommendation engine 265 are not a unitary event. Both operate in a continuous manner whenever inputs are received. Collected information may continue to be processed depending on how the present invention is implemented. The amount of information may be regulated by either the service provider or the user.

Collected information is used to create a set of recommendations for new media as shown in a step 640, earlier shown in step 530. From the set of recommendations, information may be delivered to the computing device 240, handheld device 245, or flash handheld device 247, as shown in a step 650. Or, information may be delivered to the same devices in the form of services, indicated by a step 660.

Although embodiments have been discussed for the present invention, other devices and configurations may be implemented to operate with the present invention. The prior discussion is only for illustrative purposes to convey exemplary embodiments. Additionally, other embodiments may be employed to accomplish the same tasks. The steps discussed in FIGS. 5 and 6 may be executed without regards to order. Some steps may omitted and some steps may be executed at a different time than shown. The point here is to convey that the figures are merely exemplary for the embodiments of the present invention and that other embodiments may be implemented for the present invention.

A scenario of an embodiment suitable for practicing the present invention may be described as follows: Karim purchases a license to download music from a music service, service 290. Karim installs and activates client software onto his computer, computing device 240, and MP3 player, handheld device 245, as part of the service he receives, described in steps 610 and 620. Upon activation, the client software operates seamlessly in the background to collect data (steps 510, 610, and 620) on Karim's behavior when interacting with music files installed on his computer or on his MP3 player. Data is collected on Karim's desire to listing to soft music in the morning and his desire to list to “top 40” music in the early evenings. Data is also collected about Karim's love for songs by artist “X”. In fact, in Karim's collection, there are some pirated songs stored on Karim's computer by artist “X”.

As Karim listens to his music collection, statistics are collected from either his MP3 player or his computer. All collected data is stored on Karim's computer. The data is collected at designated times which may be adjusted by Karim or by the music service through software updates. As Karim continues to interact with his music, the collected information is exchanged between the computer and the MP3 player, user 280 in FIG. 2A. This is done in order to ensure that the computer and MP3 player have the same collected data so that the music service may provide the same information to both devices. However, if Karim so chooses, he could keep separate information at each device so that the information that he receives from the music service is customized for the device, user 280 in FIG. 2B.

Independent of the synchronization that may occur between the computer and the MP3 player, the collected data is sent to a server, server 260, within the music service over an internet connection, Internet 250. This action involves steps 520 and 630. The server may contain a complement of computers running algorithms to develop recommendations, recommendation engine 265, for new music to send to Karim, steps 530 and 640. The server may have access to other computers across the internet to provide additional services to Karim.

In this scenario, the server automatically provides a list of new music that Karim might like, steps 540 and 650. Karim may access this information in several ways: on a web page at his computer, on the MP3 player, or in an email. Other ways to communicate and receive information are possible with implementing other embodiments of the present invention. Alternatively, since Karim has a subscription to the music service, it is possible to do the following: New music may automatically be downloaded onto Karim's computer. It may also be downloaded onto the MP3 player directly from the music service or through the synchronized connection to the computer. See steps 550 and 660.

From the collected data gathered earlier, Karim may receive a play list of soft music for his morning listening time and a play list of “top 40” music for his late afternoon listening time. The computer and/or the MP3 player may be programmed to begin playing the play lists at designated time, and these play lists may be changed periodically by the music service using Karim's subsequent behaviors to update future play lists.

In addition to the aforementioned, Karim may receive, as part of the music service, information that artist “X” has an upcoming concert and that admission tickets may be purchased. One may note that various portals may be accessed to allow the purchasing of concert tickets after the initial information has been provided to Karim. Also, Karim may receive a notification that some of the downloaded music on his computer or MP3 player from artist “X” is not licensed. Karim may be notified that a particular file has bad metadata or that the file has been pirated. The music service offers Karim an opportunity to clean the bad metadata by selling or providing Karim a valid license.

Throughout the scenario above, very little action was required of Karim. He did not perform tasks other than subscribe to the music service and possibly install client software. As shown, the present invention operates seamlessly making and adjusting recommendations, selections, and offers to Karim's behavior. For example, if on Monday, Karim listens to country music, then recommendations, selections, and offers may be based on country music. If, on the following week, Karim listens to classical music, then the corresponding recommendations, selections, and offers may migrate to this type of music. The more data collected on Karim's behavior, the more Karim's music desires may be anticipated.

A second scenario involves Oliver who enjoys watching videos and subscribes to a visual media service. The visual media service is configured so that Oliver uses client software installed on his computer, computing device 240, as well as client software installed on a digital video recorder (DVR), steps 610 and 620. Whenever Oliver watches a movie on a television connected to the DVR or on his computer, information is collected and periodically sent to the visual media service about Oliver's behavior interacting with the movies, steps 510, 520, and 630. The video media service may recommend future video selections, steps 530 and 640. It may also offer purchases and/or rentals of new video correlating to Oliver's movie preferences, steps 540 and 650. The video media service may also inform Oliver of new video releases, steps 550 and 660. As mentioned in the previous scenario, Oliver may receive new information from the video media service in various ways. Some of those ways include receiving information at Oliver's computer, via email, or at the television through the DVR.

One may note that the scenarios provided above describe embodiments of the present invention and are not meant to be the only ways to implement the present invention. As stated throughout this discussion, other embodiments are possible to implement the present invention to interact with various types of digital media.

The invention claimed is:

1. A computer-implemented method for recommending media, comprising:
at a first computing device, seamlessly collecting information from a user indicative of the user's behavior to media;
communicating the collected information to at least a second computing device to create a set of recommendations for additional media as a function of the collected information; and
receiving the set of recommendations from the second computing device.

2. The computer-implemented method of claim 1, wherein collecting information on the user's behavior to media comprises at least one of:
collecting purchase patterns of the user;
collecting a play list of the media created by the user;
collecting ratings information from the user regarding the user's behavior to media;
collecting a number of times the user has played a media;
collecting the number of times the user included the media in the play list;
determining the media that the user avoids;
determining when the media is played; and
determining when the media was last played.

3. The computer-implemented method of claim 2, further comprising exchanging between a playing device and the first computing device a set of information associated with the user's behavior and the media.

4. The computer-implemented method of claim 2, wherein collecting information comprises at least one of collecting information in a background unnoticeable to the user and inconspicuously operating computer software to collect the information.

5. The computer-implemented method of claim 2, wherein the media is selected from the group comprising audio, video, and documents.

6. The computer-implemented method of claim 5, wherein communicating the collected information to at least the second computing device comprises at least one of:
sending collected information from the first computing device to the second computing device;
sending collected information from the playing device;
storing collected information from the first computing device onto the second computing device; and
synchronizing changes to the collected information between the first computing device and the second computing device.

7. The computer-implemented method of claim 1, further comprising receiving at least one of the additional media, a customized offering, a concert information, a new media release, an automatic download of additional media, a clean metadata associated with downloaded media, and a valid license for downloaded media.

8. The computer-implemented method of claim 7, further comprising receiving content at the playing device.

9. A computer system having a processor, a memory and an operating environment, the computer system operable to execute the method as recited in claim 1.

10. One or more computer-readable media having instructions stored thereon for performing the method of claim 1.

11. A computer-implemented method for recommending media, comprising:
at a server, providing a client software to install onto at least a first client, the client software operating to collect information indicative of a user's behavior to media;
receiving collected information at the server to create a set of recommendations for new media; and
providing the set of recommendations to the first client or a second client.

12. The computer-implemented method of claim 11, wherein receiving collected information comprises:
receiving purchase patterns of the user;
receiving a play list of the media created by the user;
receiving ratings information from the user regarding the user's behavior to media,
receiving a number of times the user has played a media,
receiving the number of times the user included the media in the play list;
receiving data about the media that the user avoids;
receiving data on the time and date when the media is played; and
receiving data about when the media was last played.

13. The computer-implemented method of claim 12, further comprising exchanging between the first client and the second client a set of information associated with the user's behavior and the media.

14. The computer-implemented method of claim 13, wherein the media is selected from the group comprising audio, video, and documents.

15. The computer-implemented method of claim 14, further comprising providing at least one of the new media, a customized offering, a concert information, a new media release, an automatic download of new media, a clean metadata associated with downloaded media, and a valid license for downloaded media.

16. A computer system having a processor, a memory and an operating environment, the computer system operable to execute the method as recited in claim 11.

17. One or more computer-readable media having instructions stored thereon for performing the method of claim 11.

18. A system for recommending media, comprising:
a server, with a recommendation engine, in communication with at least one of a first client and a second client;
the server operable to receive user data indicative of a user's behavior to a first media;
the recommendation engine operable to create a set of recommendations for a second media; and
the server operable to provide the set of recommendations to the first client or the second client.

19. The system of claim 18, wherein the user data comprises at least one of:
purchase patterns of a user;
a play list of the media created by the user;
ratings information from the user regarding the user's behavior to media;
a number of times the user has played the media;
the number of times the user included the media in the play list;
the media that the user avoids;
the time and date when the media is played; and
data about when the media was last played.

20. The system of claim 19, further comprising the server operable to provide at least one of the second media, a customized offering, a concert information, a new media release, an automatic download of the second media, a clean metadata associated with downloaded media, and a valid license for downloaded media.
